(19) United States
(12) Patent Application Publication
(10) Pub. No.: US 2010/0071997 A1
(43) Pub. Date: Mar. 25, 2010

(54) Adjustable Hunting Stand

(76) Inventor: Michael C. Green, Ridgeland, MS (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/490,160

(22) Filed: Jun. 23, 2009

Related U.S. Application Data
(60) Provisional application No. 61/074,850, filed on Jun. 23, 2008.

(51) Int. Cl. A01M 31/02

(52) U.S. Cl. 182/187

(57) ABSTRACT

A hunting stand is disclosed. The stand includes a base for mounting on a tree or post, platform connected to the base and an adjustable support arm connected to the base and the platform. The platform is configured to support a hunting animal, such as a dog, above a body of water or a ground surface. The hunting stand is quickly and easily adjustable such that it can be mounted on a section of a tree or post that is substantially non-vertical, has a substantially crooked center line and/or has a substantially non-uniform cross-sectional shape.

### CROSS-REFERENCE TO RELATED APPLICATIONS

This application claims the benefit of U.S. Provisional Application No. 61/074,850, filed on Jun. 23, 2008, the entire disclosure of which is incorporated herein by reference.

### BACKGROUND

The present disclosure relates to a hunting stand for a hunting animal such as a dog.

When hunting game or, more particularly, water fowl such as ducks in or around a body of water, a hunter will often use a dog to retrieve the game from the body water. The hunter may provide the dog with a hunting stand, or dog stand, that is mounted on a tree or post and includes a support platform extending substantially horizontally above the body of water. Thus, the dog can rest on the platform between retrievals.

Conventional dog stands lack sufficient adjustability. In order for the support platform of the stand to extend substantially horizontally above the body of water, the stand must be mounted on a section of a tree or post that is substantially vertically oriented, has a substantially straight center line, and/or has a substantially uniform cross-sectional shape. In a preferred hunting location, it may be difficult or impossible to mount to find such a tree or post. Furthermore, conventional dog stands are difficult and/or time consuming to set up. It is therefore desirable to provide a dog stand that is adjustable such that it can be mounted on sections of trees or posts that are significantly non-vertical, have a substantially crooked center line, and/or have a substantially irregular cross-sectional shape. It is further desirable to provide a dog stand that sets up quickly and easily and can be collapsed into a compact configuration for transport or storage.

### SUMMARY

An adjustable hunting stand is disclosed. The stand may be adapted for supporting a hunting animal such as a dog, and may be used during hunting sessions or training sessions for the animal. Furthermore, the stand may be adapted to support a human or other load.

In some implementations, a hunting stand includes a base configured to be secured to a tree or a post, a platform connected to the base and configured to support a load, and a support arm having a variable length, wherein the support arm is connected to the base and the platform such that varying the length of the support arm varies an angle of inclination between the base and the platform, thereby permitting an adjustment of a level of the platform. The platform may be pivotally connected to the base, and the support arm may be pivotally connected to the base and the platform.

In some implementations, the support arm may include first and second arm members that are movable with respect to each other to vary the length of the support arm. A locking mechanism may be provided to secure the first and second arm members together and set the length of the support arm.

In some implementations, the stand may be collapsed into a substantially flat configuration for transporting or storing the stand.

Additional features and advantages will be apparent to those skilled in the art with reference to the following detailed description and appended drawing figures.

### BRIEF DESCRIPTION OF THE DRAWINGS

FIG. 1 is a perspective view of a dog stand mounted on a tree, according to various implementations of the invention.

FIG. 2 is a side view of the dog stand in an assembled configuration for use according to various implementations of the invention.

FIG. 3 is a top view of the dog stand in the assembled configuration according to various implementations of the invention.

FIG. 4 is a front view of the dog stand in the assembled configuration according to various implementations of the invention.

FIGS. 5-7 are side views of the dog stand in a partially disassembled configuration according to various implementations of the invention

FIG. 8 illustrates the dog stand collapsed into a transport or storage configuration according to various implementations of the invention.

Corresponding reference characters indicate corresponding parts throughout the several views of the drawings.

### DETAILED DESCRIPTION

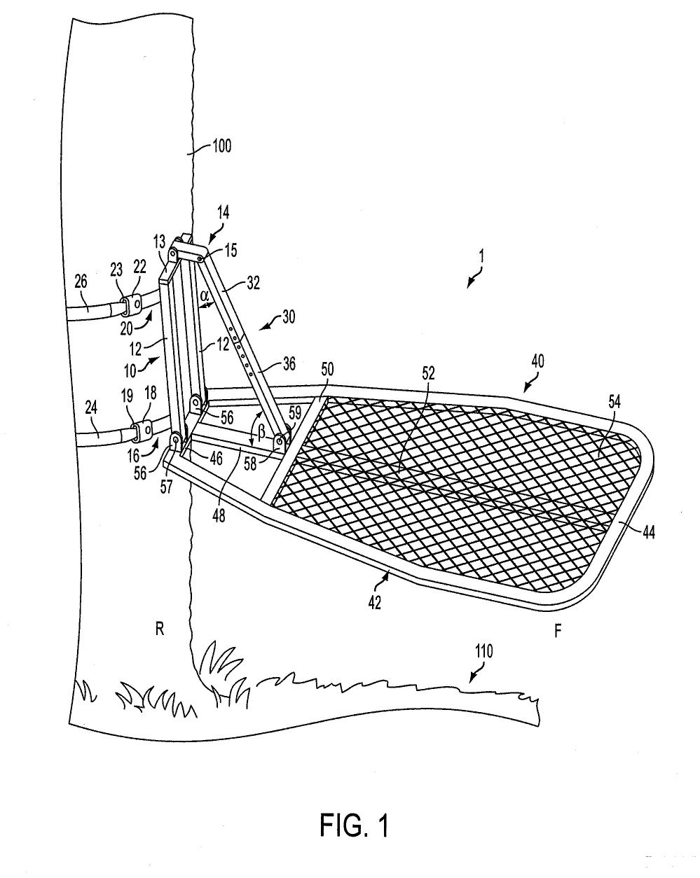

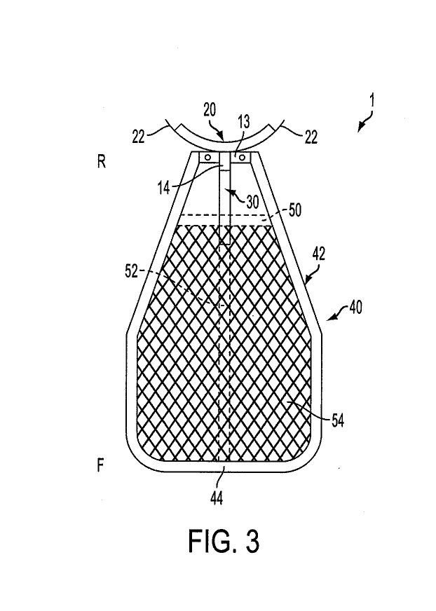

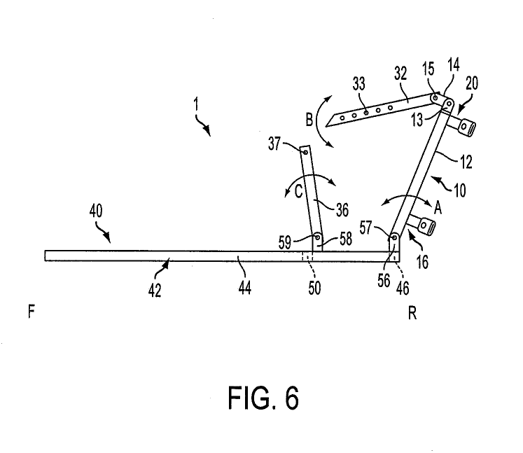

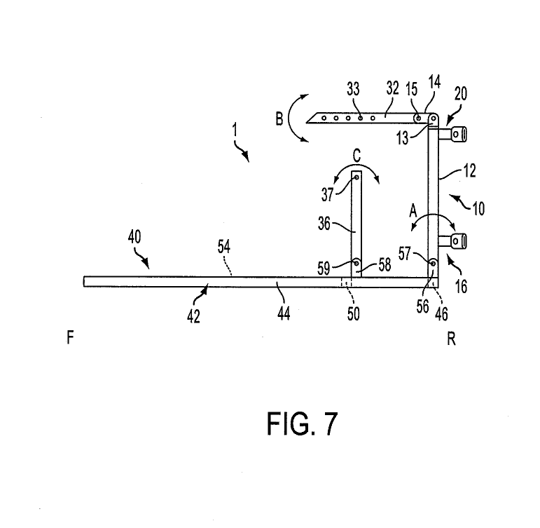

FIGS. 1-8 illustrates a hunting stand or dog stand 1 according to various implementations of the invention. The stand 1 may be used for hunting game such as birds, ducks or other water fowl. The stand 1 is particularly adapted for mounting on a tree or a post above a body of water, and provides a structure upon which a dog, other hunting animal or human can rest between retrievals of game. The structure may also be used to support any animate or inanimate load.

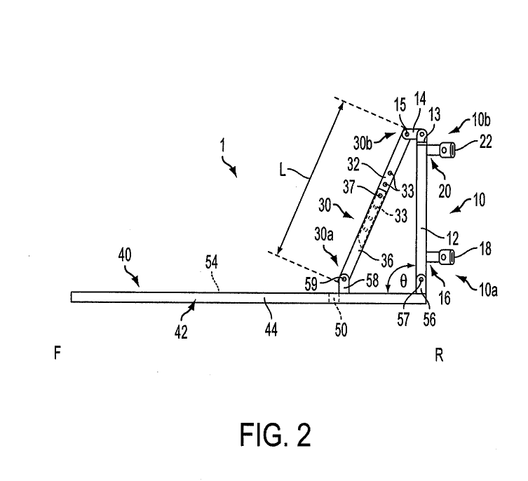

Referring to FIGS. 1-4, which illustrate the stand 1 in a configuration for use, the hunting stand 1 includes a base 10 located at a rear end R of the stand 1, an adjustable support arm 30 and a platform 40 configured to support a load imparted by a dog, other hunting animal or human. As is described later in more detail, the platform 40 is pivotally connected to a bottom end 10a (FIG. 2) of the base 10, and the support arm 30 is pivotally connected to the platform 40 and a top end 10b (FIG. 2) of the base 10. The base 10, the support arm 30 and the platform 40 may be constructed of aluminum, steel, plastic, or any another suitable material.

The base 10 may include a pair of elongate members or tubes 12 which extend substantially parallel to each other in a spaced relationship. The elongate members 12 each have a bottom end at the bottom end 10a of the base 10 and a top end at the top end 10b of the base 10. The base further includes a cross member 13 connected to the top end of the elongate members 12 and extending transversely between the elongate members 12, and a mounting bracket 14 connected to the cross member 13. The base 10 further includes upper and lower curved mounting arms or tubes 16, 20 connected to the elongate members 12 and spaced apart along the length of the elongate members 12. The elongate members 12, cross member 13 and arms 16, 20 may be aluminum, steel, or plastic tubes, for example. However, other materials and structures may be used. The arms 16, 20 and the cross member 13 may be welded to the elongate members 12, or the arms 16, 20 and the cross member 13 may be fastened to the elongate members 12 with fastening hardware. The mounting bracket 14 may be welded or fastened to the cross member 13.

Each mounting arm 16, 20 includes a pair of strap clips 18, 22 disposed at opposite ends of the arm 16, 20. Each strap clip 18 includes an opening 19 for receiving a strap 24, and each strap clip 22 includes an opening 23 for receiving a strap 26. As illustrated in FIG. 1, the base 10 may be secured to a tree trunk 100 with the mounting arms positioned against the tree trunk 100, and with the straps 24, 26 extending around the tree trunk 100 and secured to opposite ends of the respective mounting arms 16, 20. Specifically, ends of the strap 24 may be secured in the openings 19 of the clips 18, and ends of the strap 26 may be secured in the openings 23 of the clips 22. The straps 24, 26 may be adjusted to fit snugly around the trunk 100 so as to hold the base 10 firmly against the trunk 100.

The platform 40 extends substantially horizontally, transversely to the base 10, from the rear end R to a front end F of the stand 1. A illustrated in FIG. 1, in use, the platform 40 may extend over a body of water 110 or a ground surface. The platform 40 includes a frame 42 and a substantially flat deck 54 supported by the frame member 42 and forming a top surface of the platform 40. The frame 42 may be constructed of tubular aluminum, steel or plastic, and the deck 54 may be constructed of aluminum, steel, or plastic mesh or a sheet of steel, metal or aluminum or plastic, for example. However, other materials and constructions are possible.

The frame 42 includes a substantially U-shaped member 44, a rear transverse member 46 extending between free end portions at a rear end of the U-shaped member 44, and an intermediate transverse member 50 extending between opposite sides of the U-shaped member 44 and disposed forward of the rear transverse member 46 in the frame 42. A first longitudinal member 48 extends between the rear transverse member 46 and the intermediate transverse member 50, and a second longitudinal member 52 extends between the intermediate transverse member 50 and a front end of the U-shaped member 44. The transverse members 46, 50 may be welded or fastened to the U-shaped member 44. Similarly, the longitudinal member 48 may be welded or fastened to the transverse members 46, 50 and the longitudinal member 52 may be welded or fastened to the intermediate transverse member 50 and the U-shaped member 44. In some implementations, the frame 42 may have a unibody construction instead of components connected by welding or fastening.

The deck 54 may extend between the opposite sides of the U-shaped member 44 and between the intermediate transverse member 50 and the front end of the U-shaped member 44. The deck 54 may be welded or fastened to top surfaces of the members 44, 50, 52.

The frame further includes mounting brackets 56 disposed on the rear transverse member 46. The brackets 56 may be welded or fastened to the rear transverse member. The bottom ends of the elongate members 12 of the base 10 are secured to the brackets 56 with bolts or pins 57 such that the platform 40 is pivotally connected to the base 10 at brackets 56.

The support arm 30 extends obliquely between the base 10 and the platform 40 and has an adjustable length L (FIG. 2). The support arm 30 includes a first arm member or slip tube 32 and a second arm member or slip housing 36. A top end of the first arm member 32, which forms a top end 30b (FIG. 2) of the support arm 30, is pivotally connected to the mounting bracket 14 of the base 10 with bolts or pins 15. The first arm member 32 is secured to the second arm member 36 with a locking mechanism 37. A bottom end of the second arm member 36, which forms a bottom end 30a (FIG. 2) of the support arm 30, is pivotally connected to a mounting bracket 58 of the frame 42 with a bolt or pin 59. As illustrated, the mounting bracket 58 is disposed on the first longitudinal member 48 of the frame 44, forward of the rear end of the stand 1. However, in some implementations, the mounting bracket 58 may be provided at a different position on the platform 40 if desired. The mounting bracket 58 may be welded or fastened to the frame 44. By way of the connections described above, the support arm 30 is pivotally connected to the base 10 and the platform 40.

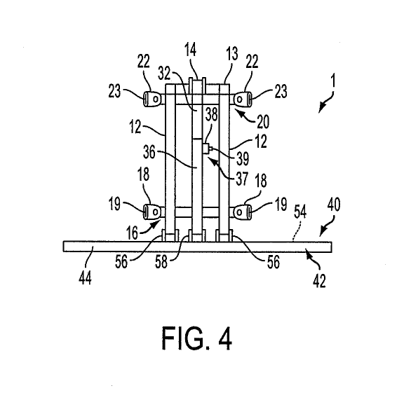

As illustrated in FIG. 4, the first arm member 32 is slidably received in the second arm member 36 and includes a plurality of holes 33 which are spaced apart along the length of the first arm member 32. Still referring to FIG. 4, the locking mechanism 37 includes a fastener housing 38 welded or fastened to the second arm member 36 and a fastener 39 disposed within the housing 38 (FIG. 4). The fastener 39 may be a bolt or a pin such as a spring-loaded pin or snap-pin. One of the holes 33 may be engaged by the fastener 39 to secure the first arm member 32 to the second arm member 36 and set the length L of the support arm 30. The length L of the support arm 30 can be adjusted as needed by disengaging the fastener 39 from a hole 33, sliding the first arm member 32 within the second arm member 36 to either increase or reduce the length L, and then engaging a different hole 33 with the fastener 39. As the length L of the support arm 30 is adjusted, the platform 40 pivots with respect to the base 10 (or vice-versa) to change the angle 6 between the base 10 and the platform 40 (FIG. 2). Additionally, adjusting the length L of the support arm 30 causes the support arm 30 to pivot with respect to the base 10 (or vice-versa) to vary the angle a between the support arm 30 and the base 10, and causes the platform 40 to pivot with respect to the support arm 30 (or vice-versa) to vary the angle between the platform 40 and the support arm 30. In this manner, the platform may be adjusted to be substantially level over, for example, the body of water

While the first and second arm members 32, 36 are illustrated and described as being a slip tube and a slip housing, it should be understood that other types of arm members may be used. For example, in some implementations, the first and second arm members 32, 36 may be replaced with first and second arm members in the form of rods or substantially flat bars (such as angle iron), that are slidable with respect to each other and may be secured together via engagement between a pin provided on the second arm member and one of a plurality of holes in the first arm member. Still further, the first and second arm members 32, 36 may be secured together with a clamp instead of the locking mechanism 37. In some implementations, the first and second arm members 32, 36 may be replaced with a single telescoping arm.

Due to adjustable length L of the support arm 30, the pivoting connection between the platform 40 and the base 10, the pivoting connection between the support arm 30 and the base 10, and the pivoting connection between the platform 40 and the support arm 30, the platform 40 can be oriented to extend substantially horizontally even when the stand 1 is mounted on a section of a tree trunk or post that is substantially non-vertical, has a crooked center line, and/or has a substantially non-uniform cross-sectional shape. Specifically, variation of the length L of the support arm 30 results in variation of the angle of inclination 8 between the platform 40 and the base 30, and therefore the level of the platform 40 above, for example, the body of water. Thus, the orientation of the platform 40 can be adjusted as desired. As a result, the platform 40 can provide a level, stable surface on which a hunting animal can rest or stand, even when the tree or post to which the stand 1 is mounted does not extend perfectly vertically or is not perfectly shaped.

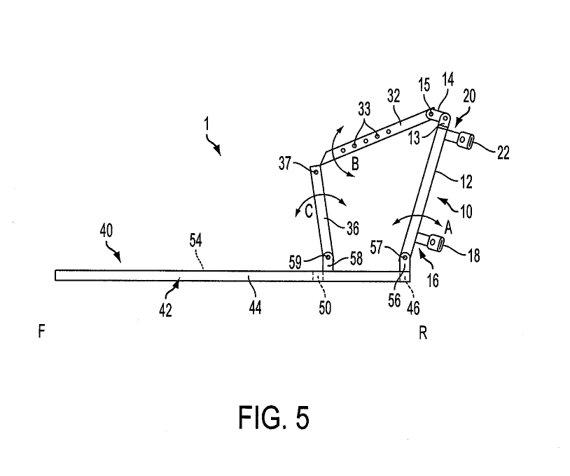

FIGS. 5-7 show the stand 1 in partially disassembled configurations to illustrate the manner in which the base 10, the support arm 30 and the platform 40 can pivot. Specifically, the platform 40 and/or the base 10 can pivot about the bolts or pins 57 as indicated by the arrow A, the base 10 and/or the first arm member 32 can pivot about the bolt or pin 15 as indicated by the arrow B, and the platform 40 and/or the second arm member 36 can pivot about the bolt or pin 59 as indicated by the arrow C. The bolts or pins 15, 57, 29 each define pivot axes that extend in the transverse direction of the stand 1 (i.e., perpendicular to the front-to-rear length of the stand 1).

Referring back to FIG. 1, the stand 1 can be quickly mounted on the tree trunk 100 (or a post) by first securing the mounting arms 16, 20 to the tree using the straps 24, 26, and subsequently adjusting the length L of the support arm 30 and pivoting the platform 40 such that the platform 40 extends substantially horizontally at a level above the body of water 110 (or a ground surface). In some cases, it is desirable to have the platform 40 positioned only a few inches above the body of water 110.

Typically, the stand will be configured as illustrated in FIG. 1, with the top end 10b of the base positioned above the bottom end 10a of the base 10 and the platform 40. However, it is possible to invert the orientation of the stand 1, such that the bottom end 10a of the base 10 is positioned above the top end 10b of the base. In such an inverted orientation, the bottom end 10a and the top end 10b of the base 10 effectively form a top end and a bottom end, respectively, of the base 10, and the top bottom end 30a and the top end 30b of the support arm 30 effectively form a top end and a bottom end, respectively, of the support arm 30. When the stand 1 is in the inverted orientation, it may be necessary for a portion of the base 10 to be positioned below a surface of a body of water. Additionally, if it is desired to use the stand 1 in the inverted orientation, a second deck (not illustrated) may be connected to the frame 42, on an opposite surface of the frame 42 with respect to the deck 54.

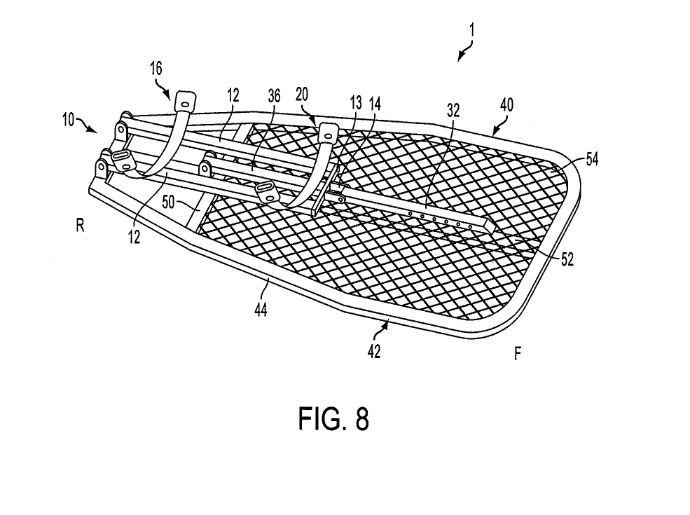

Additionally, the stand 1 can be quickly and easily converted to a collapsed transport or storage configuration, as illustrated in FIG. 8. In a first step of converting the stand 1 to the transport or storage configuration, the first arm member 32 and the second arm member 36 are disconnected and removed from each other and the second arm member 36 is pivoted about the bolt or pin 59 towards the front end F of the stand 1, such that the second arm member 36 rests on the platform 40 and extends substantially parallel to the platform 40. Thereafter, the base 10 is pivoted about the bolts or pins 57, towards the front end F of the stand 1, such that the base rests on the platform 40 and extends substantially parallel to the platform 40. As a result, the second arm member 36 is positioned between the elongate members 12 on the platform 40. As the base 10 is pivoted, the first arm member 32 is pivoted about the bolt or pin 15 towards the front F of the platform 40. The first arm member 32 is then placed on the platform 40 such that the first arm member 32 extends substantially parallel to the platform 40. When in the storage or transport configuration, the stand 1 is substantially flat and relatively compact, thereby facilitating transport or storage of the stand 1.

The foregoing disclosure provides various illustrative implementations of the invention and is not intended to be limiting. It should be understood that modifications of the disclosed implementations are possible within the spirit and scope of the invention, and the invention should be construed to encompass such modifications.

What is claimed:

1. A hunting stand comprising:
a base configured to be secured to a tree or a post;
a platform connected to the base, the platform being configured to support a load; and
a support arm having a variable length, the support arm being connected to the base and the platform such that varying the length of the support arm varies an angle of inclination between the base and the platform, thereby permitting an adjustment of a level of the platform.

2. The hunting stand of claim 1, wherein the support arm comprises a first arm member connected to the base and a second arm member connected to the platform, and wherein the first arm member and the second arm member are movable with respect to each other to vary the length of the support arm.

3. The hunting stand of claim 2, comprising a locking mechanism configured to lock the first arm member and the second arm member together to set the length of the support arm.

4. The hunting stand of claim 2, wherein the first arm member is a slip tube and the second arm member is a slip housing, and wherein the first arm member is slidable within the second arm member.

5. The hunting stand of claim 4, wherein:
the slip tube comprises a plurality of holes spaced apart along a length of the slip tube; and
the locking mechanism comprises pin configured to selectively engage the holes to set the length of the support member.

6. The hunting stand of claim 1, wherein the platform is pivotally connected to the base.

7. The hunting stand of claim 6, wherein the support arm is pivotally connected to the base and the platform.

8. The hunting stand of claim 1, wherein:
the platform extends from a rear end of the stand to a front end of the stand;
the platform is pivotally connected to a first end of the base at the rear end of the stand;
a first end of the support arm is pivotally connected to a second end of the base; and
a second end of the support arm is pivotally connected to the platform at a position forward of the rear end of the stand.

9. The hunting stand of claim 1, wherein, when the stand is in a configuration for use, the platform extends substantially horizontally, the base extends transversely with respect to the platform and the support arm extends obliquely between the base and the platform.

10. The hunting stand of claim 1, wherein the platform is connected to a top end of the base.

11. The hunting stand of claim 1, wherein the platform is connected to a bottom end of the base.

12. The hunting stand of claim 1, wherein :
the platform extends from a rear end of the stand to a front end of the stand;
the platform is pivotally connected to a bottom end of the base at the rear end of the stand;
a top end of the support arm is pivotally connected to a top end of the base; and
a bottom end of the support arm is pivotally connected to the platform at a position forward of the rear end of the stand.

13. The hunting stand of claim 1, wherein:
the platform extends from a rear end of the stand to a front end of the stand;
the platform is pivotally connected to a top end of the base at the rear end of the stand;
a bottom end of the support arm is pivotally connected to a bottom end of the base; and
a top end of the support arm is pivotally connected to the platform at a position forward of the rear end of the stand.

14. The hunting stand of claim 1, wherein the base comprises:
at least one elongate member having a first end and a second end, the platform being connected to the first end of the at least one elongate member; and
a mounting bracket connected to the second end of the at least one elongate member, the support arm being connected to the mounting bracket.

15. The hunting stand of claim 14, wherein the at least one elongate member comprises a pair of elongate members extending substantially parallel to each other and in spaced relationship to each other.

16. The hunting stand of claim 1, wherein the stand is collapsible into a transport or storage configuration in which the base and the support arm extend substantially parallel to the platform.

17. The hunting stand of claim 16, wherein:
the support arm comprises a first arm member pivotally connected to the base and a second arm member pivotally connected to the platform;
the platform and the base are pivotally connected to each other; and
the stand is collapsible into the storage or transport configuration by disconnecting the first arm member from the second arm member, pivoting the base and the second arm member with respect to the platform, and pivoting the first arm member with respect to the base.

18. The hunting stand of claim 17, wherein:
the base comprises a pair of elongate members extending substantially parallel to each other and in spaced relationship to each other; and
the second arm member extends between the elongate members when the stand is in the storage or transport configuration.

19. The hunting stand of claim 1, comprising a pair of curved mounting arms connected to the base member and configured to engage a tree or post, each of the curved mounting arms having opposite ends configured to receive ends of a strap extending around the tree or post.

20. The hunting stand of claim 1, wherein the load corresponds to a hunting animal.
